(19) United States
(12) Patent Application Publication
(10) Pub. No.: US 2014/0267074 A1
(43) Pub. Date: Sep. 18, 2014

(54) SYSTEM AND METHOD FOR VIRTUAL USER INTERFACE CONTROLS IN MULTI-DISPLAY CONFIGURATIONS

(71) Applicant: QUALCOMM INCORPORATED, San Diego, CA (US)

(72) Inventors: Murat Balci, Orlando, FL (US); Hitendra Mohan Gangani, Orlando, FL (US); Avinash Seetharamaiah, Chuluota, FL (US)

(73) Assignee: QUALCOMM INCORPORATED, San Diego, CA (US)

(21) Appl. No.: 13/830,738

(22) Filed: Mar. 14, 2013

(51) Int. Cl. G06F 3/041

(52) U.S. Cl. CPC G06F 3/041
USPC 345/173

(57) ABSTRACT

Methods, devices, and computer program products for virtual user interface controls in multi-display configurations are described herein. In one aspect, an electronic device includes a processor configured to generate a first image of the screen, the first image of the screen not containing a touch-sensitive user interface, generate a second image, the second image comprising a touch-sensitive user-interface configured to be overlayed onto the first image of the screen, transmit one or more of the first image of the screen and the second image to the first display device, and output the first image of the screen to a second display device.

### FIELD

The present application relates generally to user interface controls, and more specifically to systems, methods, and devices for virtual user interface controls in multi-display configurations.

### BACKGROUND

Electronic devices offer a variety of different types of user interfaces. For example, many devices, such as interactive televisions, portable computers, tablets, mobile telephones, music devices, and other electronic devices may offer a user interface that is based upon touch screen technology. In such an electronic device, a user may interact with the device by touching the screen of the device. These devices may use a variety of touch screen technologies, such as capacitive or resistive touch screen technologies.

Touch-screen devices may provide a user with a wide variety of virtual user interface elements which are designed to be used with a touch screen. For example, touch-screen devices may provide a user, at certain times, with an on-screen virtual keyboard. This virtual keyboard may contain letters, numbers, and/or symbols, such as emoticons, for a user to select from. A user may type on the virtual keyboard by touching various portions of the screen corresponding to a virtual key on the virtual keyboard.

At times, it may be desirable to attach one or more other displays to an electronic device. For example, a user of an electronic device may wish to attach an external display to the device. These other displays may or may not have the same user interface capability offered by the first display. Thus, improved systems, methods, and devices for virtual user interface controls in multi-display configurations are desired.

### SUMMARY

The systems, methods, devices, and computer program products discussed herein each have several aspects, no single one of which is solely responsible for its desirable attributes. Without limiting the scope of this invention as expressed by the claims which follow, some features are discussed briefly below. After considering this discussion, and particularly after reading the section entitled “Detailed Description,” it will be understood how advantageous features of this invention include reduced power consumption when introducing devices on a medium.

Some aspects of the disclosure describe a device which comprises a first display device; and a processor configured to: generate a first image of the screen, the first image of the screen not containing a touch-sensitive user interface; generate a second image, the second image comprising a touch-sensitive user-interface configured to be overlayed onto the first image of the screen; transmit one or more of the first image of the screen and the second image to the first display device; and output the first image of the screen to a second display device.

In one aspect, a method of for providing a virtual user interface in a multi-display configuration is disclose. The method comprises generating a first image of the screen, the first image of the screen not containing a touch-sensitive user interface; generating a second image, the second image comprising a touch-sensitive user-interface configured to be overlayed onto the first image of the screen; transmitting one or more of the first image of the screen and the second image to the first display device; and outputting the first image of the screen to a second display device.

In one aspect, a non-transitory, computer readable medium comprising instructions that when executed cause a processor in a device to perform a method of transmitting clock drift information in an ad-hoc wireless communication network is disclosed. The method comprises generating a first image of the screen, the first image of the screen not containing a touch-sensitive user interface; generating a second image, the second image comprising a touch-sensitive user-interface configured to be overlayed onto the first image of the screen; transmitting one or more of the first image of the screen and the second image to the first display device; and outputting the first image of the screen to a second display device.

In another aspect, a device is disclosed comprising means for generating a first image of the screen, the first image of the screen not containing a touch-sensitive user interface; means for generating a second image, the second image comprising a touch-sensitive user-interface configured to be overlayed onto the first image of the screen; means for transmitting one or more of the first image of the screen and the second image to the first display device; and means for outputting the first image of the screen to a second display device.

### BRIEF DESCRIPTION OF THE DRAWINGS

FIG. 1 is a perspective view of a tablet computer and secondary display set up on a prior art clone mode.

FIG. 2 is a perspective view of a tablet and a secondary display arranged according to one embodiment.

FIG. 3 is a flowchart of an exemplary process for optimized virtual user interface controls in a multi-display configuration.

FIG. 4 is a flowchart of an exemplary process for optimized virtual user interface controls in a multi-display configuration.

FIG. 5 depicts a block diagram of a device for optimized virtual user interface controls in a multi-display configuration.

### DETAILED DESCRIPTION

Embodiments relate to systems, methods, and devices for properly displaying virtual user interface controls in multi-display configurations. For example, a tablet computer may allow a user to plug in an external display, such as a computer monitor or a television. However, this second or external display may not offer the same user interface capability of the built-in screen on the tablet computer. For example, the second display may not offer touch-screen capabilities. This disclosure describes systems, methods and devices for optimizing virtual user interface controls in a multi-display configuration.

Thus, for example, a touch-screen tablet computer may be connected to a standard computer monitor as a secondary display. When the tablet is set to display it's screen on the secondary display, the system may analyze what is being displayed to add or remove certain interface elements from the secondary display. Thus, if the tablet computer begins to display a touch-screen keyboard, in one example, the system may determine that this keyboard does not need to be displayed on the secondary display, and thereafter prevent it from being shown on the secondary display. This prevents the secondary display from showing interface elements, such as a keyboard, that are necessary for operating the tablet computer, but interfere with the view presented on the secondary display.

Many electronic devices feature screens with user interface capabilities, such as touch screens. Touch screens may commonly be found, for example, on tablet computers, mobile phones, electronic music devices, televisions, laptop and desktop computers, and on a wide variety of other devices. In many instances, these electronic devices may also be configured to allow a user to removably attach one or more secondary displays to the device and thus be useful with embodiments of the present invention.

The word “exemplary” is used herein to mean “serving as an example, instance, or illustration.” Any embodiment described herein as “exemplary” is not necessarily to be construed as preferred or advantageous over other embodiments. Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

FIG. 1 is an illustration of a known setup for displaying a tablet screen in a “clone mode” on a second display. In this illustration, electronic device 105 is attached to a second display 110. Electronic device 105 has a built-in touch screen display 115. Electronic device 105 is configured to, at certain times, display a virtual keyboard 120 on its built-in touch screen display 115. For example, electronic device 105 may be configured to display virtual keyboard 120 when a cursor on the built-in touch screen display 115 is in a text-input box. This virtual keyboard 120 may provide a convenient way for a user to input text into the electronic device 105.

However, when electronic device 105 is attached to the second display 110, the second display 110 will display the same information as the built-in touch screen display 115. For example, this may occur in a clone mode on the electronic device 105, wherein the built-in touch screen display 115 and the second display 110 are configured to display the same information. Thus, the second display 110 may also display the virtual keyboard 120. In some instances, the second display 110 may not offer the same user interface capability as the built-in touch screen display 115. For example, the second display 110 may be an external display such as a computer monitor or a television, and may not offer touch screen capabilities. Thus, the display of the virtual keyboard 120 on the second display 110 may not be beneficial to a user, as the user may not be able to interact with the virtual keyboard 120 on the second display 110. Instead, the virtual keyboard 120 on the second display 110 may merely take up a large amount of space on the second display 110, and obscure other information that is underneath the area where the virtual keyboard 120 is drawn.

FIG. 2 is an illustration of a perspective view of a configuration of a tablet computer and secondary display, where the tablet computer includes instructions according to embodiments of the invention for offering an improved clone mode on the second display. As shown, the electronic device 205 is attached to a second display 210. Electronic device 205 may have a built-in touch screen display 215. Electronic device 205 may be configured to display a virtual keyboard 220 on its built-in touch screen display 215 at least some of the time. For example, electronic device 205 may be configured to display virtual keyboard 220 when a cursor on the built-in touch screen display 215 is in a text-input box. This virtual keyboard 220 may provide a convenient way for a user to input text or other information into the electronic device 205. The electronic device 205 may also include other user interface elements which may be configured to be used with a touch screen display, a multi-touch display, or a display offering other user input capability.

In some aspects, electronic device 205 may have a number of different modes for the second display 210. For example, electronic device 205 may offer modes to a user which can extend a desktop onto the second display 210, such that the built-in touch screen display 215 and the second display 210 may display different information and content from each other. In some aspects, the electronic device 205 may have an improved clone mode, as illustrated in FIG. 2. In the improved clone mode, the built-in touch screen display 215 and the second display 210 usually display identical information, that is, the second display 210 is a “clone” of the built-in touch screen display 215. However, at certain times, the built-in touch screen display 215 may display user interface overlays over at least a portion of the display. These user interface overlays may include, for example, a virtual keyboard 220 which may be optimized for use with a touch screen display. In the improved clone mode of FIG. 2, the electronic device 205 may be configured to display user interface overlays, such as the virtual keyboard 220, only on the touch screen display 215 and not display these overlays on second display 210.

In some aspects, the electronic device 205 may be configured to determine the user interface capability of the second display 210, and to display overlays on the second display 210 based at least in part on the user interface capability of the second display. For example, the electronic device 205 may be configured to determine whether or not the second display 210 is a touch screen. If the second display is a touch screen, the electronic device 205 may be configured to transmit one or more overlay user interface images to the second display 210, based upon the touch screen capabilities of the second display 210. However, if the second display 210 is not a touch screen, the electronic device 205 may be configured not to transmit the overlay images to the second display 210.

In some aspects, user interface components which may be added to a screen image, such as virtual keyboard 220, may be overlay images. For example, the electronic device 205 may generate an image of the screen that does not contain any user interface elements, and may generate one or more user interface elements, which may be overlayed on the image of the screen. The electronic device 205 may transmit the image of the screen to both the built-in touch screen display 215 and the second display 210. The electronic device 205 may also transmit one or more user interface overlays to the built-in touch screen display 215 and/or the second display 210. In some aspects, the electronic device 205 may be configured to transmit the user interface overlays only to the built-in touch screen display 215.

In some aspects, the electronic device 205 may separately transmit the image of the screen and the user interface overlays to the displays. In some aspects, the electronic device 205 may be configured to combine the image of the screen and the user interface overlays, if any, into a single image before transmitting the image to the built-in touch screen display 215 and/or the second display 210. The electronic device 205 may be configured to transmit different images of the screen, differing in which if any overlay images are added to the screen, to the built-in touch screen display 215 and the second display 210. In some aspects, the use of overlay images for this purpose may allow the electronic device 205 to more easily provide slightly differing images to the built-in touch screen display 215 and the second display 210. This approach may require less computing power that separately generating two different images of the screen. This approach may also allow the electronic device 205 to achieve better performance, to use less costly graphics components, to require less graphics memory, and to reduce power consumption compared to other approaches which may require more processing power.

FIG. 3 is a flowchart for exemplary process 300 of an optimized virtual user interface controls in a multi-display configuration. This process 300 may be executed by a device, such as electronic device 205. This process 300 may be used as a mode on an electronic device 205 for multi-display configurations. For example, the process 300 may be used as a clone mode, or an improved clone mode on an electronic device 205.

At block 305, the electronic device 205 generates a first image of a screen not containing a touch-sensitive user interface.

At block 310, the electronic device 205 generates a user interface overlay. This user interface overlay may be an image that can be overlayed on top of the first image of the screen, in order to provide some sort of user interface. The user interface overlay may be configured to provide a user interface for touch screens. For example, the user interface overlay may comprise a virtual keyboard, or other overlay, which may allow a user to input letters, numbers, symbols, or other information to the device. In some aspects, the electronic device 205 may generate two or more user interface overlays. These user interface overlays may be configured to be displayed on the same display, or may be configured to be displayed on different displays, depending upon the user interface capabilities of the display. For example, one user interface overlay may be generated which is configured to be displayed on a multi-touch display, while another user interface overlay may be generated which is configured to be displayed on a touch screen display without multi-touch capability. In some aspects, the electronic device 205 may only generate a user interface overlay some of the time. For example, the electronic device 205 may be configured to only display a virtual keyboard or other form of user interface overlay when a cursor is in an area suitable for typing text. Thus, the electronic device 205 may be configured to only generate a virtual keyboard overlay when the virtual keyboard is to appear. In some aspects, generating a user interface overlay may comprise loading a user interface overlay image, such as the image of a virtual keyboard, from a memory.

At block 315, the electronic device 205 transmits the first image of the screen and the user interface overlay to a first display. The first image and the user interface overlay may be transmitted separately to the first display, or may be combined into a single image prior to being transmitted to the first display. For example, the electronic device 205 may overlay the user interface overlay onto the first image, and may generate a single image containing both the first image and the overlay, and transmit this single image to the first display. In some aspects, the electronic device 205 may transmit two or more user interface overlays to the first display. For example, two or more user interface overlays may be placed onto the first image of the screen and transmitted to the first display. In some aspects, the electronic device 205 may generate multiple user interface overlays, and may choose which of these overlays to transmit to the first display based, at least in part, on the user interface capability of the first display. For example, if the first display is not capable of multi-touch input, the electronic device 205 may not transmit to the first display user interface elements which may require or be optimized for multi-touch capability.

At block 320, the electronic device 205 outputs the first image to an attached second display device. In some aspects, the electronic device 205 may be configured to determine the user interface capability of the second display device. The electronic device 205 may be configured to output only the first image, without a user interface overlay, to the second display device if the second display device is not capable of accepting user input. For example, if the second display device is not a touch screen device, the electronic device 205 may be configured to output the first image to the attached second display device. In some aspects, the second display device may be removably attached to the electronic device. For example, the electronic device 205 may be a tablet computer or another device with one or more ports that can attach to an external display, such as HDMI ports, serial ports, or other ports. In some aspects, the electronic device 205 may be configured to determine whether an external display device is attached to a port. In some aspects, the electronic device 205 may offer two or more different modes for display on a second display device, and the process 300 of FIG. 3 may be used if one of those modes, such as a clone mode, is selected.

FIG. 4 is a flowchart for exemplary process 400 of an optimized virtual user interface controls in a multi-display configuration. This process 400 may be executed by a device, such as electronic device 205. This process 400 may be used as a mode on an electronic device 205 for multi-display configurations. For example, the process 400 may be used as a clone mode, or an improved clone mode on an electronic device 205.

At block 405, the electronic device 205 generates a first image of a screen not containing a touch-sensitive user interface.

At block 410, the electronic device 205 generates one or more user interface overlays. These one or more user interface overlays may be images that can be overlayed on top of the first image of the screen, in order to provide a user interface. For example, these one or more user interface overlays may be configured to provide a user interface for touch screens. For example, the one or more user interface overlays may comprise a virtual keyboard, or other overlays, which may allow a user to input letters, numbers, symbols, or other information to the electronic device 205. Different user interface overlays may be configured to operate with different types of user interface capabilities of screens. For example, one user interface overlay may be configured to be used with screens capable of receiving multi-touch input while other user interface overlays may be configured to be used with a stylus-based input or with other input methods.

At block 415, the electronic device 205 receives a user interface capability of a first display device. The first display device may be built-in to the electronic device 205, or may be attached to the electronic device 205 in a removable manner. The electronic device 205 may obtain the user interface capability of the first display device from a memory. This memory may be built-in to the electronic device 205. For example, if the first display device is built-in to the electronic device 205, the user interface capabilities of the first display device may be stored on a memory which the electronic device 205 can access. In some aspects, the electronic device 205 may determine the user interface capability of the first display device. For example, the electronic device 205 may be configured to query the first display device in order to determine the user interface capability of the first display device, such as to determine whether the first display device is a touch-screen display and to determine other features of the first display device.

At block 420, the electronic device 205 transmits one or more of the first image and the one or more user interface overlays to the first display device based on the user interface capabilities of the first display device. This transmission may comprise transmitting a single combined image to the first display device. For example, if the first display device is a touch-screen device, the electronic device 205 may combine the first image with one or more touch-screen user interface overlays in a single image to be transmitted to the first display device. In some aspects, the one or more user interface overlays may be stored in a memory that is accessible to a module on the electronic device 205. For example, the one or more user interface overlays may be contained in a memory that is accessible to a driver, such as a display driver, on the electronic device 205. This driver may be configured to receive or determine the capabilities of displays which at attached to the electronic device 205, and may be configured to generate different images for multiple displays if multiple displays are in use and if these displays have different user input capabilities, in certain modes and when user input overlays are being used. At other times, for example if two displays are in use with identical user input capabilities or if only one display is attached to the electronic device 205, the driver may be configured to generate only a single version of an image of the screen.

At block 425, the electronic device 205 receives a user interface capability of a second display device. The second display device may be attached to the electronic device 205. For example, the second display device may be removably attached via a port such as an HDMI port, a serial port, or another port. The second display device may comprise any type of display, such as a computer monitor, a television, or another type of display. The second display device may or may not include features such as a touch screen. The electronic device 205 may be configured to determine the capabilities of the second display device, or may be configured to receive the capabilities of the second display device from a memory. For example, the electronic device 205 may be configured to query the second display device in order to determine the user interface capability of the second display device, such as to determine whether the second display device is a touch-screen display and to determine other features of the second display device.

At block 430, the electronic device 205 transmits one or more of the first image and the one or more user interface overlays to the second display device based on the user interface capabilities of the second display device. This transmission may comprise transmitting a single combined image to the second display device. For example, if the first display device is a touch-screen device, the electronic device 205 may combine the first image with one or more touch-screen user interface overlays in a single image to be transmitted to the second display device. The electronic device 205 may be configured to have multiple modes. This process 400 may be just one more of operation of the electronic device 205. For example, process 400 may be used is a user selects a clone mode as a multi-display configuration.

The use of overlay images, which may be added to the first image may be simpler and require less processing than drawing two completely separate screens for a first and second display device. Thus, the electronic device 205 may be able to operate more efficiently, to use less power, to achieve higher performance, or to use less expensive components or less memory than a device using another method. The use of an improved clone mode may also allow the displays on a second display, which may not be able to receive touch input, to be used more efficiently, rather than obscuring those displays with large touch screen user interface elements which may not be used.

FIG. 5 depicts a high-level block diagram of a device 500 having a set of components including a processor 520 operatively coupled to a first display device 515 and a second display device 525. A working memory 505, storage 510, and memory 530 are also in communication with and operative attached to the processor. Device 500 may be a cell phone, desktop or laptop computer, or another device. For example, device 500 may be a tablet device with an image output port and a touch-screen display. A plurality of applications may be available to a user on device 500.

Processor 520 may be a general purpose processing unit or a processor specially designed for the disclosed methods. As shown, the processor 520 is connected to a memory 530 and a working memory 505. In the illustrated embodiment, the memory 530 stores image generation module 535, image overlay module 540, image output module 555, capability determination module 560, and operating system 575. These modules include instructions that configure the processor to perform various tasks. Working memory 505 may be used by processor 520 to store a working set of processor instructions contained in the modules of memory 530. Alternatively, working memory 505 may also be used by processor 520 to store dynamic data created during the operation of device 500.

As mentioned above, the processor 520 is configured by several modules stored in the memories. For example, the image generation module 535 may include instructions that configure the processor 520 to generate an image of a screen containing a number of graphical elements. For example, image generation module 535 may contain instructions for generating images of the screen to a user to display elements of the operating system 575 interface, or any applications that are being used. This image of the screen may contain no user input elements designed for a touch screen, for example.

The memory 530 may also contain an image overlay module 540. The image overlay module 540 may contain instructions to configure the processor 520 to generate one or more user interface overlays which can be overlayed onto an image of a screen, in order to provide a user interface. For example, the image overlay module 540 may contain instructions to instruct the processor 520 to generate an on-screen keyboard which may be used with a touch-screen in order to allow a user to type on the screen using the touch-screen. The image overlap module 540 may contain instructions to have the processor 520 generate these overlay images, or may have instructions to configure the processor 520 to load and use overlay images stored in, for example, storage 510.

The device 500 may also be operatively attached to a first display device 515 and a second display device 525. For example, the first display device 515 may be built-into the device 500, such as if the device 500 is a tablet computer, and the first display device is a built-in screen. In some aspect, the first display device 515 may be a touch-screen display. In some aspects, the second display device 525 may be operatively attached to the device 500 using a port, such as a DVI, HDMI, or other display port. In some aspects, the second display device 525 may or may not contain user interface capabilities. For example, the second display device 525 may be a touch-screen device, or it may also be a non-touch-screen device, such as an LED monitor, a plasma television, or another non-touch-screen display. In some aspects, the second display device 525 may be a display that is removably attached to the device 500 by a user, in order to provide a larger display area for the device 500.

The device 500 may also include an image output module 555. The image output module 555 may contain instructions to configure the processor 520 to create and output an image to send to each of the first display device 515 and the second display device 525. For example, the image output module 555 may contain instructions to configure the processor 520 to overlay one or more user interface overlays from the image overlay module 540 onto the image generated by the image generation module 535. In some aspects, the image output module 555 may contain instructions to overlay user interface overlays onto an image that is then outputted to the first display device, but may not overlay user interface overlays onto an image that is then outputted to the second display device 525. In some aspects, the image output module 555 may work with the capability determination module 560 in order to generate the images to output to each of the first display device 515 and/or the second display device 525. For example, the capability determination module 560 may contain instructions to configure the processor 520 to determine user interface capabilities of each of the first display device 515 and the second display device 525. For example, the capability determination module 560 may determine whether one or both of these devices are touch-screen devices. Similarly, the image output module 555 may contain instructions to configure the processor to output images containing various user interface overlays to each of the first display device 515 and second display device 525, based at least in part on the user interface capabilities of each of these devices, as determined by the capability determination module 560. In some aspects, the image output module 555 may be configured to have access to the user interface capabilities of the first display device 515. For example, the user interface capabilities of the first display device 515 may be known, because the first display device 515 may be permanently built-in to the device 500. In some aspects, the user interface capabilities of the first display device 515 may be stored in the storage 510.

Operating system module 575 configures the processor to manage the memory and processing resources of device 500. For example, operating system module 175 may include device drivers to manage hardware resources such as the first display device 515, storage 510, or second display device 525. Therefore, in some embodiments, instructions contained in modules discussed above may not interact with these hardware resources directly, but instead interact through standard subroutines or APIs located in operating system component 575. Instructions within operating system 575 may then interact directly with these hardware components.

Processor 520 may write data to storage module 510. While storage module 510 is represented graphically as a traditional disk device, those with skill in the art would understand multiple embodiments could include either a disk based storage device or one of several other type storage mediums to include a memory disk, USB drive, flash drive, remotely connected storage medium, virtual disk driver, or the like.

FIG. 5 depicts a device having separate components to include a processor, first display device, and memory, one skilled in the art would recognize that these separate components may be combined in a variety of ways to achieve particular design objectives. For example, in an alternative embodiment, the memory components may be combined with processor components to save cost and improve performance.

Additionally, although FIG. 5 illustrates two memory components, to include memory component 530 having several modules, and a separate memory 505 having a working memory, one with skill in the art would recognize several embodiments utilizing different memory architectures. For example, a design may utilize ROM or static RAM memory for the storage of processor instructions implementing the modules contained in memory 530. Alternatively, processor instructions may be read at system startup from a disk storage device that is integrated into device 500 or connected via an external device port. The processor instructions may then be loaded into RAM to facilitate execution by the processor. For example, working memory 505 may be a RAM memory, with instructions loaded into working memory 505 before execution by the processor 520.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may include one or more elements.

A person/one having ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

A person/one having ordinary skill in the art would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein and in connection with FIGS. 1-4 may be implemented within or performed by an integrated circuit (IC), an access terminal, or an access point. The IC may include a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. The logical blocks, modules, and circuits may include antennas and/or transceivers to communicate with various components within the network or within the device. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The functionality of the modules may be implemented in some other manner as taught herein. The functionality described herein (e.g., with regard to one or more of the accompanying figures) may correspond in some aspects to similarly designated “means for” functionality in the appended claims.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A device, comprising:
a first display device; and
a processor configured to:
generate a first image of the screen, the first image of the screen not containing a touch-sensitive user interface;
generate a second image, the second image comprising a touch-sensitive user-interface configured to be overlayed onto the first image of the screen;
transmit one or more of the first image of the screen and the second image to the first display device; and
output the first image of the screen to a second display device.

2. The device of claim 1, wherein the touch-sensitive user interface comprises a virtual keyboard.

3. The device of claim 1, wherein the processor is configured to transmit one or more of the first image of the screen and the second image to the first display device, based at least in part on a user interface capability of the first display device.

4. The device of claim 3, wherein the processor is further configured to determine the user interface capability of the first display device.

5. The device of claim 3, wherein the processor is further configured to retrieve the user interface capability of the first display device from a memory.

6. The device of claim 1, wherein the first display device comprises a touch-sensitive display.

7. The device of claim 1, the processor further configured to determine a mode of the device.

8. The device of claim 1, the processor further configured to:
receive a user interface capability of the second display device; and
if the user interface capability of the second display device is sufficient, output the first image of the screen and the second image to the second display device.

9. The device of claim 8, wherein the processor is further configured to determine the user interface capability of the second display device.

10. The device of claim 8, wherein the processor is further configured to retrieve the user interface capability of the second display device from a memory.

11. The device of claim 1, wherein the second display device is removably attached to the device.

12. The device of claim 1, wherein the processor is further configured to determine whether a second display device is attached to the device.

13. A method of for providing a virtual user interface in a multi-display configuration, the method comprising:
generating a first image of the screen, the first image of the screen not containing a touch-sensitive user interface;
generating a second image, the second image comprising a touch-sensitive user-interface configured to be overlayed onto the first image of the screen;
transmitting one or more of the first image of the screen and the second image to the first display device; and
outputting the first image of the screen to a second display device.

14. The method of claim 13, wherein the touch-sensitive user interface comprises a virtual keyboard.

15. The method of claim 13, wherein transmitting one or more of the first image of the screen and the second image to the first display device, comprises transmitting one or more of the first image of the screen and the second image to the first display device, based at least in part on a user interface capability of the first display device.

16. The method of claim 15, further comprising determining the user interface capability of the first display device.

17. The method of claim 15, further comprising retrieving the user interface capability of the first display device from a memory.

18. The method of claim 13, wherein the first display device comprises a touch-sensitive display.

19. The method of claim 13, further comprising determining a mode of the device.

20. The method of claim 13, where outputting the first image of the screen to a second display device comprises:
receiving a user interface capability of the second display device; and
if the user interface capability of the second display device is sufficient, outputting the first image of the screen and the second image to the second display device.

21. The method of claim 20, wherein receiving a user interface capability of the second display device comprises determining the user interface capability of the second display device.

22. The method of claim 20, wherein receiving a user interface capability of the second display device comprises retrieving the user interface capability of the second display device from a memory.

23. The method of claim 13, wherein the second display device is removably attached to the device.

24. The method of claim 13, further comprising determining whether a second display device is attached to the device.

25. A non-transitory, computer readable medium comprising instructions that when executed cause a processor in a device to perform a method of transmitting clock drift information in an ad-hoc wireless communication network, the method comprising:
generating a first image of the screen, the first image of the screen not containing a touch-sensitive user interface;
generating a second image, the second image comprising a touch-sensitive user-interface configured to be overlayed onto the first image of the screen;
transmitting one or more of the first image of the screen and the second image to the first display device; and
outputting the first image of the screen to a second display device.

26. A device, comprising:
means for generating a first image of the screen, the first image of the screen not containing a touch-sensitive user interface;
means for generating a second image, the second image comprising a touch-sensitive user-interface configured to be overlayed onto the first image of the screen;
means for transmitting one or more of the first image of the screen and the second image to the first display device; and
means for outputting the first image of the screen to a second display device.
